(19) United States
(12) Patent Application Publication
(10) Pub. No.: US 2021/0197913 A1
(43) Pub. Date: Jul. 1, 2021

(54) HANDLEBAR SYSTEMS AND METHOD

(71) Applicants: Carla Marie Montez, Aurora, CO (US); Landis Arnold, Niwot, CO (US)

(72) Inventors: Carla Marie Montez, Aurora, CO (US); Landis Arnold, Niwot, CO (US)

(21) Appl. No.: 17/090,472

(22) Filed: Nov. 5, 2020

Related U.S. Application Data
(63) Continuation-in-part of application No. 15/832,208, filed on Dec. 5, 2017, now Pat. No. 10,858,061.
(60) Provisional application No. 62/507,967, filed on May 18, 2017.

(51) Int. Cl. B62J 45/20; B62J 50/22; B62K 21/12; B62J 27/00

(52) U.S. Cl. CPC B62J 45/20; B62J 27/00; B62K 21/12; B62J 50/22

(57) ABSTRACT

A handlebar system; the system provides a multi-functional handlebar component for a cycle or similar vehicle. Versions of the system include a housing containing a battery; a handlebar mount configured to attach to the cycle, a subcomponent housing; an energy storage module mechanically coupled to the subcomponent housing; a user interface fixed to the subcomponent housing, and including a speaker, a microphone, and at least one manual input, the user interface adapted to communicate a command from a user; a communication module fixed to the subcomponent housing and electrically coupled to the energy storage module, the communication module including a transceiver electrically coupled to the energy storage module, the transceiver configured to communicate with at least one external communication network wirelessly; and a memory electrically coupled to the energy storage module.

### CROSS-REFERENCE TO RELATED APPLICATION

This application is a continuation-in-part and is related to U.S. patent application Ser. No. 15/832,208 filed Dec. 5, 2017, allowed, which is related to and claims priority to U.S. Provisional Patent Application No. 62/507,967, filed May 18, 2017; these applications are entirely incorporated into this document by this reference.

### BACKGROUND OF THE INVENTION

### Field of the Invention

The present invention generally relates to the field of attachments and accessories for land vehicles and relates to attachments and accessories for motorcycles and bicycles, including communication devices.

### Description of Related Art

Mobile smart devices incorporating communication technologies have become an indispensable aspect of people's daily lives. The expanding availability of smartphones, tablets, and similar mobile communication devices has been changing how we receive, send, and control information. It is not always convenient to use these devices during certain activities. Bicycle and motorcycle riders are often restricted in safely interacting with such devices and exchanging information while riding. But there are many situations where the availability of services and devices having voice and digital communication and various other device interactions can bring safety, convenience, and other value to the rider on or close to their cycle. New technologies addressing this issue, such as incorporating currently-unavailable features within a handlebar upgrade, would benefit many riders.

A wide range of interactive and non-interactive computing functions may enhance the riding experience. For example, riders may want to record their rides for entertainment or safety reasons. Bike racing competitors may want to record their ride to identify incorrect techniques and improve their race times. Others may want to document a route or area during a ride. Operators may want to monitor their parked cycles' security using their smart devices. Rental operators may want to send and receive information about the bike or rider. A system designed to address these needs would be of great benefit in this field.

Prior attempts have been made to address these issues. For example, U.S. Pub. No. 2014/899,501 to Hines et al. relates to a bicycle system, especially to bicycle systems adapted for use with smartphones, to smartphones configured for use with bicycle systems, to methods and computer software for use with bicycle systems or smartphones, and to servers configured to communicate with bicycle systems or smartphones.

One version provides a bicycle, including a battery integral to the bicycle to power microprocessor, the bicycle system including a smartphone holder configurable to receive a smartphone and to connect the smartphone to the processor. In use, the smartphone holder is attachable to and detachable from the smartphone. Some advantages of the system include charging a smartphone, receiving information from the processor such as bicycle-maintenance-related information, checking the smartphone identity to uncover unauthorized use of the bicycle system, holding a smartphone during bicycle system travel, and improving the aerodynamics of the integrated bicycle system versus bolted on systems.

The above-noted reference fails to provide the combined multi-functional structures and features of the Applicant's disclosed handlebar system and method. The above-noted reference fails to disclose a handlebar-mounted, two-way communication technology capable of communicating with an external network, which can operate with or independently of the cycle operator's mobile communication devices. The functional components of the above-noted reference are spread throughout the bike rather than conveniently combined within the handlebar. Thus, the handlebar system disclosed below can be installed in new bikes and may upgrade nearly any bike without requiring significant changes to the cycle or its architecture.

### BRIEF SUMMARY OF THE INVENTION

Because of the preceding disadvantages inherent in the known attachments-and-accessories-for-land-vehicles art, the present disclosure provides a novel handlebar system and method. The present disclosure provides a multifunctional handlebar for a cycle or similar vehicle providing that vehicle with communication technology.

A handlebar system for a cycle is disclosed. The handlebar system may include a handlebar configured to attach to and steer the cycle, the handlebar having a left-hand end, a right-hand end, a cross-member extending between the left-hand and right-hand ends, the cross-member including a subcomponent housing. Also, the handlebar system may include an energy storage module mechanically coupled to the subcomponent housing, a user interface as a part of the handlebar, which is attached to or associated with the subcomponent housing, and including a speaker, a microphone, and at least one manual input, the user interface adapted to communicate a command from a user.

The handlebar system may further include a communication module fixed to the subcomponent housing and electrically coupled to the energy storage module, the communication module including a transceiver electrically coupled to the energy storage module, the transceiver configured to communicate wirelessly with at least one external communication network. The handlebar system may include a memory electrically coupled to the energy storage module, the memory configured to store an application, the application operable to communicably couple the communication module with at least one external communication network using the transceiver and establish a full-duplex communication link and provide for the interoperation of the communication module and the user interface.

Also, the handlebar system may include a processor inside or embedded in the subcomponent housing, electrically coupled to the energy storage module, and communicably coupled to the communication module, the memory, and the user interface, the processor configured to execute the application upon detecting user interaction with the handlebar system.

A method of augmenting a handlebar of a cycle is also disclosed. Such method includes the steps of providing a handlebar configured to attach to and steer the cycle, the handlebar having a left-hand end and a right-hand end, left and right being in some geometries reversible, extending a cross-member between the left-hand end and right-hand end, the cross-member including a subcomponent housing, mechanically coupling an energy storage module to the subcomponent housing, fixing a user interface to the subcomponent housing, the user interface including a speaker, a microphone, and at least one manual input, the user interface adapted to communicate a command from the user, embedding a communication module in the subcomponent housing, the communication module including a transceiver electrically coupled to the energy storage module, the transceiver configured to wirelessly communicate with at least one external communication network, embedding a memory in the subcomponent housing, and the memory electrically coupled to the energy storage module, the memory configured to store an application, the application operable to communicably couple the communication module with at least one external communication network using the transceiver and establish a communication link and provide for interoperation of the communication module and the user interface; and embedding a processor in the subcomponent housing, the processor electrically coupled to the energy storage, and communicably coupled to the communication module, the memory, and the user interface, the processor configured to execute the application upon detecting user interaction with the handlebar system. The method may further include the step of installing the handlebar on the cycle.

### DESCRIPTION OF THE DRAWINGS

The figures which accompany the written portion of this specification illustrate the present disclosure, a handlebar system and method.

FIG. 1 is a perspective view of a handlebar system during an “in-use” condition.

FIG. 2 is a detailed view of the handlebar system of FIG. 1.

FIG. 3 is an exploded perspective view of the handlebar system of FIG. 1.

FIG. 4 is a schematic diagram of the handlebar system of FIG. 1.

FIG. 5 is a perspective view of the handlebar system.

FIG. 6 is a perspective view of the handlebar system of FIG. 5.

FIG. 7 is a detailed view of a user interface of the handlebar system of FIG. 5.

FIG. 8 is a detail view of an alternate user interface of the handlebar system of FIG. 5.

FIG. 9 is an exploded view of an alternate set of handgrips incorporating a removable battery pack of the handlebar system of FIG. 5.

FIG. 10 is a flow diagram illustrating a method of use for the handlebar system.

### DETAILED DESCRIPTION

Versions of the present disclosure relate to attachments and accessories for land vehicles and, more particularly, to a handlebar system and method to improve the attachments and accessories for enhancing motorcycles and bicycles.

Generally, the versions of the present disclosure provide multi-functional handlebars for cycles and similar vehicles having handlebar-type steering. The disclosed handlebar system may provide a wide range of enhanced functions and features, including:

A) Wireless communication capability within bicycles, tricycles, velomobiles, E-bikes, scooters, and motorcycles, collectively called “cycles”. There are many examples where a convenient means for establishing a real-time communication link with a remote individual or site while riding would greatly benefit cyclists or bikers. Holding a cell phone or similar communication device during a ride can be difficult, disruptive to the ride, and dangerous. Having to stop the ride, pull over, and make or take a phone call can be inconvenient. For example, a rider may need to quickly call emergency services if an accident or other threatening situation occurs. Riders may want a dedicated hands-free communication system for their bike, including the ability to link an onboard system to their phone, which may be nearby (such as a pocket or bag) while riding. Bike-rental operators may want to monitor the bikes during use. Coaches and riders may want to access real-time data, recorded data, or other information during or after training sessions. All such data can be accessible to the rider during use and is available using network stream or written into data storage.

B) Integrating video-capture capability by including a video or still camera or recorder controllable from the handlebar, and controlled and displayed by a smart device, a computer such as a tablet, cell phone, or other smart device installed integral the handlebar. The handlebar system may have multiple camera lenses and connect to other distributed cameras and can manage and integrate different feeds in real time. The handlebar system may feature digital processors with digital memory devices incorporated into the handlebar system. The handlebar system may include a smart device or receive and integrally control a smart device brought to the handlebar system, using wired or wireless connection. Riders and users of vehicles and devices controlled by handlebars may desire to record their rides for documentation, information, or safety reasons. They may also want to see a video feed, such as a video feed live from their camera or transmitted or projected by a smart device computer or otherwise available. Competitive bikers and those in training may want to record their ride and monitor incorrect techniques to improve their race times and general performance effectively. Further, some people may want to have an ongoing recording of their ride to document various aspects, such as advertising a surrounding area, documenting aggressive driving around them, or recording their travels. For many reasons, the police may want to have video recording transmitted from or received by their “cycle-based info system”. Individuals or entities who have had their vehicle stolen or simply lost their vehicle may want to acquire video and location information from their remote, missing bike.

C) Integrating music and audio capability to allow cyclists and motorcycle riders to enjoy listening to music as they ride on the road, on a trail, or other environments. This capability allows for a more enriched riding experience, particularly on longer rides. The disclosed system allows riders to combine music with other tasks during a ride. Audio reception and transmission are essential in phone communications, video acquisition, projection, and related communication. Audio can also be important for police, either speaking with their station or connecting to a loudspeaker forming a bullhorn device. The ability to interoperate with “smart helmets” and other smart devices allows the disclosed system to be a control center for all these technologies.

D) Providing the capability of adding ancillary devices. Various devices and features may be added to the system to enhance a right. These may include rider and vehicle performance metrics, location devices, vehicle-to-vehicle signals, communications, and person-to-person and rider-to-vehicle communications. A variety of motorcycle, bicycle, and e-bike “monitors” can crowd and confuse the rider, yet the data can be very important in and of themselves. Security from theft and vandalism increases as the number and importance of attachments grow. Safety headlights, taillights, safety markers, and turn signals are important attachments to many bikes and are expected to become even more popular. Handlebar systems generally “attach” various devices to the handlebars, which exposes the devices to weather elements, and often increases aerodynamic forces and drag, slowing the vehicle. Also, systems are vulnerable to theft and damage while in transit and during normal usage.

Many individuals drive pedal bikes, e-bikes, scooters, exercise machines, and motorcycles for transportation or pleasure. Shared and Rental cycles of all types need smart, durable, and secure systems to monitor the cycle, accept payments from the customer, locate the cycle, and alert the vendor for service.

The present handlebar system may provide bicycles, e-bikes, scooters, exercise machines, and motorcycles with a uniquely-designed set of handlebars (customarily used for bike control, steering, stability, shifting, and braking) enhanced with the capability of making and receiving phone calls, recording, monitoring, and live-streaming video, playing music, and interacting with other system and network devices in the bike, the vicinity of the bike, and the greater Internet. These features may bring convenience and enjoyment, safety, and liability protection with an accident or altercation. They may also provide professional value regarding developing video and providing coaching-level feedback for athletes. Security, aerodynamics, aesthetics, and function is enhanced by integrating elements within the handlebar rather than generally mounting monitors and controls using attachments to the handlebars. New technologies are becoming available every year, and a modular internal handlebar platform that allows easy integration into the wide range of new and existing vehicles and devices requiring or using handlebars brings safety and many other benefits, such as expanding the use of energy-efficient transportation, which brings a wide range of societal benefits.

Vehicle-to-vehicle communications, likewise, preventing collisions and increasing safety. E-bike and other information streams from modern bikes likewise are best used when visible and understood. Allowing the rider to maximize and trust their system, their potential range, and any maintenance information, which may be available but not always easily accessed and known, improves the vehicle.

The handlebar system may provide a modular hardware interface to access these different information streams from. Audio and video integration can be achieved while protecting and securing valuable components and reducing much, parasitic aerodynamic drag.

The handlebar system can include one or multiple camera lenses designed to record video while cycling or riding a motorcycle. It can also integrate feeds from separate cameras or lenses connected to the system controls and monitors. The handlebar may optimize camera position and aerodynamics, all while integrating security features. It is foreseen that a telescoping and retractable boom may even be into the handlebar that can be positioned or hidden for camera acquisition purposes. The integral component handlebar system will feature digital processors, digital memory devices (cards, drives, and combinations and variations of such), and access other local networked storage devices so users can record and transmit live video during their ride.

Remote access to live video can be used for athletic evaluation, for security reasons, such as when a bike has been stolen, and by police and other individuals to interface with their team and to either send or receive important video or data streams. A solar charger can also provide charging ports for batteries (integral, external, and additional accessory batteries) capable of keeping the phone system powered for long durations. Such power systems allow users to maintain or recharge the handlebar system using rechargeable batteries in the handlebar or other parts of the bicycle, tricycle, e-bike, scooter, velo-mobile, or motorcycle.

The present handlebar system may also enhance an exercise experience and motivate the rider through real-time coaching, music, gamification, videos, and more. Examples of gamification include competitive challenges with others or adding the ability to participate in other learning or drills while riding, allowing exercise not to be viewed perhaps as “unproductive” periods in one's life. Taking a call while riding has similar benefits, safely and efficiently.

Ancillary connections may include integral network connectivity using the integration with smart devices accessing cellular, WiFi, and other network connectivity, options including Bluetooth, CAN bus, ANT protocol devices, and other wireless and wired connectivity to other smart devices in and around the handlebar-equipped vehicle or device.

The handlebar may include modular elements built into its architecture to accommodate various elements such as WiFi, Global Positioning System (GPS), localized battery power, memory, data and logging, rental systems, emergency calls, emergency beacons, etc. Anti-theft devices and movement and payload lighting, such as head or taillights, police-style red and blue flashers, emergency markers, and general turn signals can all be integrated into or controlled from the handlebar system. Some of these devices require connectivity to unusual power sources. Input using interfaces, such as touch-enabled monitors, volume controls, alphanumeric keyboards, visual monitors, and complete phone, tablet, or computer interfaces, can be built into the handlebar system. Shared bike or vehicle systems need a myriad of information, transmission, and monitoring, in consistent, upgradable systems formats. Versions of the handlebar system can facilitate various cycles and connected systems to be controlled and used by rental vendors, host entities such as college and universities, corporations, and entrepreneurs. The disclosed system may assist these entities by supporting geographical mapping and providing information on nearby bike returns. System operators can determine where their vehicle may have been left, where their vehicle is now available for rent, whether their vehicle may need a service call, or whether their vehicle is in transit.

Integrating all primary systems within the handlebar achieves higher aesthetics, aerodynamics, weather protection, and interface simplification. The disclosed handlebar is configured with high and needed structural strength levels in and flexible organization of the handlebar system within the handlebar and on its surfaces. The handlebar system is adapted to enhance bicycles' functional capabilities, e-bikes, velo-mobiles, tricycles, scooters, and motorcycles. The handlebars are with various modular technological hardware devices such as Bluetooth connections, speakers, microphones, phone connectivity systems, video recording tools, battery bays, storage bays, etc.

To activate the handlebar components, riders may log in with passwords. Phone integration is a call system for handlebar-equipped vehicle or equipment. The handlebars can connect to network devices such as cell phones or related devices. The handlebar system may make and receive phone calls, texts, and other communications—the bike with ergonomic and accessible controls such as keyboards, speakers, headsets, and microphone controls. The handlebar system can be paired with a Bluetooth or tether technology system. The system can operate a headset or speakers for hands-free calling, built into the handlebars themselves. The handlebar system can be powered using a solar panel or rechargeable batteries, a generator (also called a dynamo generator), or hybrid combinations of the above-noted power sources, which may be a power supply in the bike itself.

The handlebars may work with cellular network technology. So, the system can make and receive calls. Riders will clearly hear phone calls using the system speakers, thus eliminating the need to stop a ride to access mobile communications. System speakers and microphones may integrate noise-eliminating technology. In some versions, the user's phone may be a supplemental interface. Various control systems can be used, including touch, voice control, and other usable peripherals, even “eye control” for video and system interactions. The video recording integration records video. A control panel can activate and record the videos while the speakers provide the sound. An image-capture device (such as a camera lens and CCD) can be installed in various front- and rear-facing parts of the handlebars, adjustable for direction and level. Remotely controlled panning camera systems can also function with the handlebar systems. These camera systems could control the systems integral lenses and cameras and networked cameras. Such cameras can obtain moving video and still photography with controls in the handlebar to control the cameras. Remote video, audio, and data acquisition can locate vehicles, their riders, and their riders' situation.

Users can activate the system and record video as they ride using the handlebar-equipped cycle. The video and images can be recorded or live-streamed for people to watch. The video may be stored on a digital disk drive, an SD memory card, or other local networked storage devices such as the user's cell phone.

Audio integration can play music and other audio types such as dispatch for the rider who might be a delivery person, police officer, or mobile service professional. A software application may be included, enabling music to be played during the ride. A speaker for audio and music and a headphone jack, microphone adaptor, and wireless connections to headphones or microphones can be integrated into the handlebar system. The handlebars can be installed on new and used handlebar-equipped vehicles and devices.

All components of the handlebar may be constructed using composites, alloy, steel, and other suitable structural and waterproof materials capable of supporting the stresses required of handlebars in the target vehicle. Handlebars can be made hollow or as component structure form allowing mating pieces to open and close, enhancing strength in closed and constrained shapes while allowing fabrication and configuration access. The handlebars may accommodate the loading and unloading of various elements either through a “magazine” feed system or from a detachable top and bottom clamshell aspect, which can be built intact and sealed structurally built so long-term service can be accomplished by opening and replacing critical internal elements. Top and bottom elements will combine to structurally enhance the handlebar while integrating various elements to provide safety, security, and function.

Versions of the handlebar system may include locking and quick release features that include detachment mechanisms of the handlebar, which can secure the bike (or make it unusable) and protect the handlebar's valuable systems. Remote control, monitoring, and shutdown of systems within the network-connected handlebars can facilitate security and simple “rental time agreements”. The handlebar system's network-connected nature will allow rider retrieval in times of breakdown, one-way rentals, and other services and potential requirements. The handlebar system brings a myriad of capabilities to handlebar-controlled vehicles. It does so in a flexible, contained way, and the system can be applied and used throughout handlebar-controlled vehicles in the marketplace today and those new types and variations that the future may bring. Exact size, measurement, construction, and design specifications may vary upon engineering and manufacturing requirements.

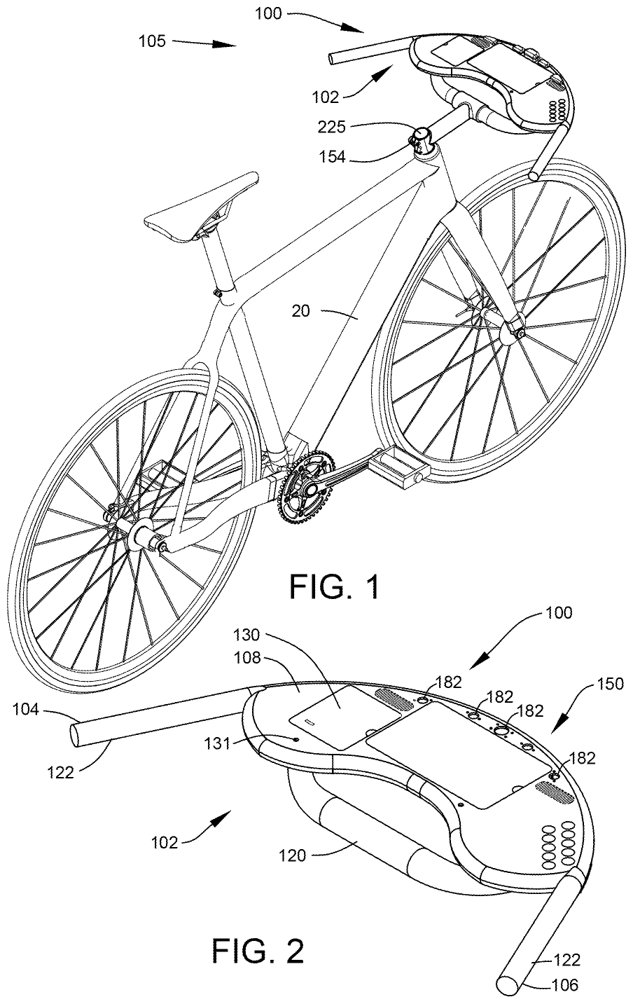

FIGS. 1-18 display various versions of a handlebar system 100. FIG. 1 shows a functionally enhanced handlebar 102 of the handlebar system 100 during an ‘in-use’ condition 105. As illustrated, the handlebar 102 is configured to attach to and steer a cycle 20 or similar vehicle. The handlebar 102 may have a left-hand end 104 and a right-hand end 106, as shown. A cross-member 120 may extend between the left-hand end 104 and right-hand end 106. The handlebar 102 may include a pair of hand grips 122 configured to assist gripping the handlebar 102. Each handgrip 122 may be attached to a respective one of the left-hand end 104 and the right-hand end 106 of the handlebar 102, as shown.

One aspect of the handlebar system 100 provides communication features permitting cyclists or bikers to establish safely and conveniently a real-time communication link with remote individuals or network sites while riding. This includes sending or receiving phone calls during operating cycle 20. The handlebar 102 includes a set of subcomponents functioning to allow the user to connect and communicate using voice, data, and radio networks, supporting messaging and data signaling, person-to-person and vehicle-to-vehicle, GPS transmission and reception and vehicular data streams between the handlebar system and other devices. This hands-free feature reduces or eliminates the need to stop the ride, pull over, and make or receive a phone call or send and receive internet data. It also allows the handlebar to be used while the bike is stationary as a computing and communications platform. Versions of the disclosed system may be configured to enter operate with the Internet of things (IoT), which is the network of physical devices, vehicles, home appliances, and other items embedded with electronics, software, sensors, actuators, and network connectivity, which enables these objects to connect and exchange data. Versions of the disclosed system are further designed to provide a communication link to a nearby user's phone or smart device engaged within the handlebar 102. In the present disclosure, the term “cycle” shall be understood to include bicycles, tricycles, velomobiles, E-bikes, scooters, motorcycles, and other vehicles and simulators which use handlebars as part of user steering, control, and hand fixation.

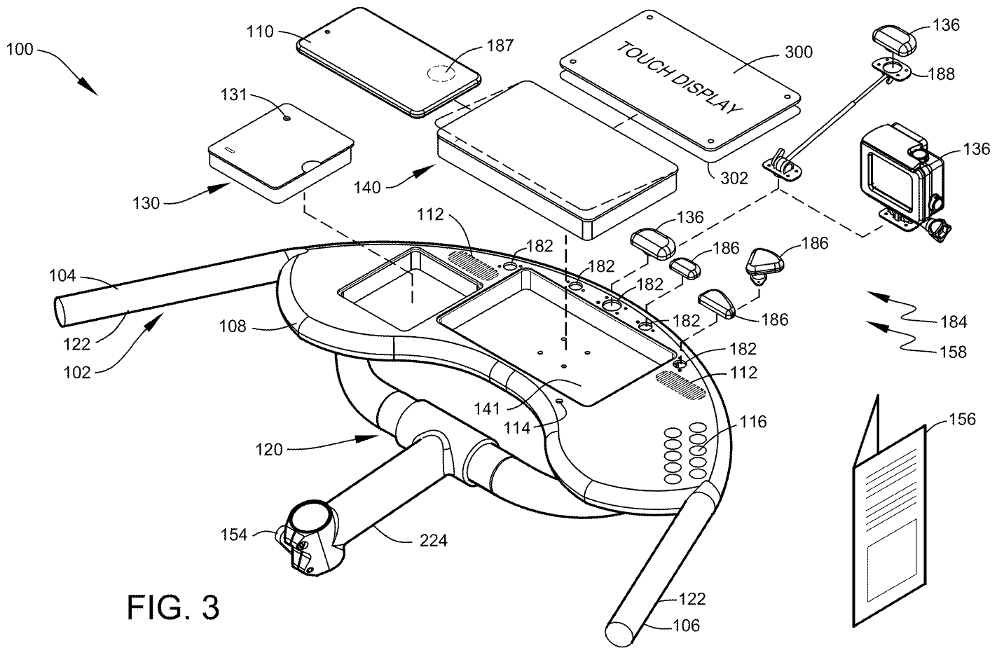

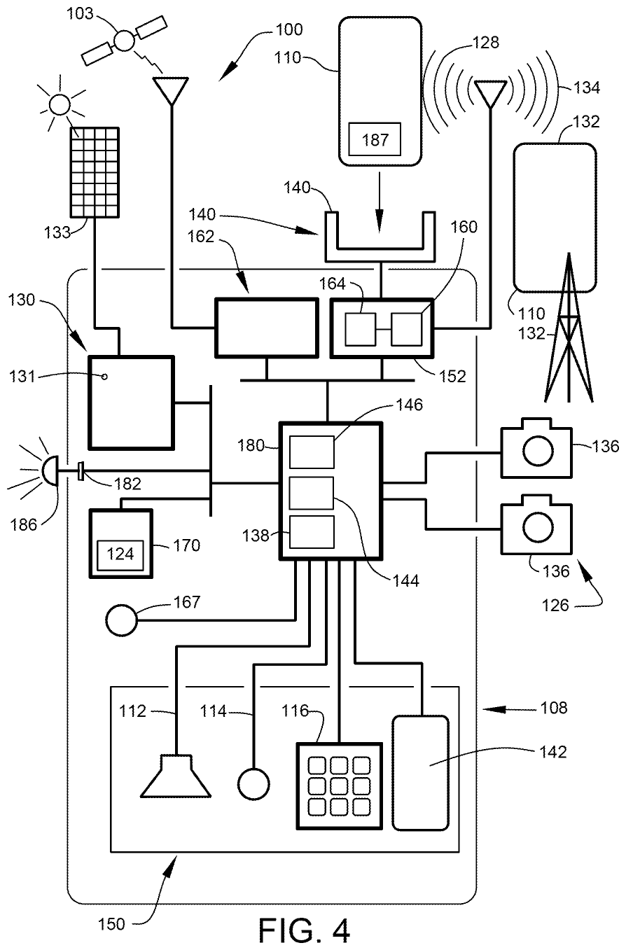

FIG. 2 is a perspective view, enlarged for clarity, of the handlebar 102, according to the version of FIG. 1. FIG. 3 is an exploded perspective view of the handlebar 102 of FIG. 1. FIG. 4 is a block diagram illustrating functional relationships between subcomponents of the handlebar 102 of FIG. 1.

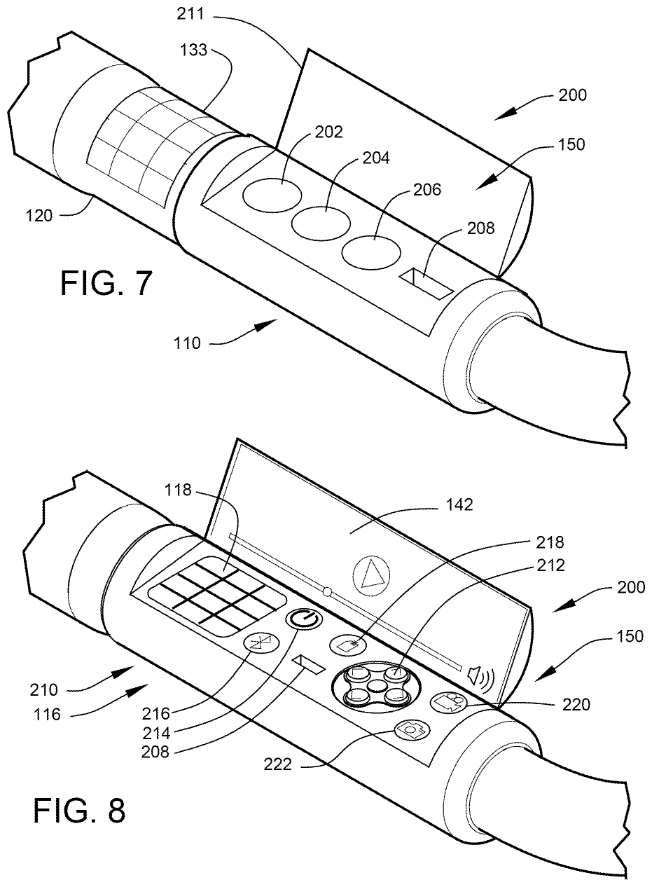

Referring to FIG. 1 through FIG. 4, the cross-member 120 may include a subcomponent housing 108, as shown. The subcomponent housing 108 may include an energy storage module 130 in an onboard battery pack or other compact power supply. The energy storage module 130 may be within the subcomponent housing 108. It may allow the user to recharge the system using rechargeable batteries in the handlebar or other parts of the cycle 20. In one version of the system, the energy storage module 130 is supplied as a removable battery (cell or battery pack), which may be mechanically coupled to the subcomponent housing 108, as shown. The housing and the removable battery pack may include a charge port 131 to enable charging of the energy storage module 130 without removing the battery. In other versions of the system, power may be supplied using a secondary source, such as a solar panel 133 (as generally illustrated in FIG. 7).

Other power arrangements such as providing an onboard DC generator using the turning of the wheels to generate electrical power, providing a means for deriving power from a mobile-computing device, using inductive recharging technology, providing an alternator delivering alternating current passed through a bridge rectifier and a bulk filter capacitor to a charger adapted to provide an appropriate output charging voltage matched to the onboard rechargeable battery, providing a battery management system to manage the onboard rechargeable battery, etc., may be sufficient.

With specific reference to FIG. 4, the handlebar 102 may include a communication module 152 fixed to the subcomponent housing 108 and electrically coupled to the energy storage module 130. The communication module 152 may include transceiver 160 configured to wirelessly communicate with at least one external wireless communication network 134. The transceiver 160 may be adapted to communicably couple with external communication networks using at least one wireless connection 128.

A human interface device identified as user interface 150 may be fixed to the subcomponent housing 108, as shown. The user interface 150 may include a speaker 112, a microphone 114, and at least one manual input 116. The user interface 150 may be adapted to communicate a command from the user; for example, the user interface 150 may control the speaker volume, receive text or voice data, or may control a user's mobile-computing device 110 remotely. In some versions, the system is configured to operate using voice commands.

Other user interface arrangements such as incorporating wireless communication technology (such as Bluetooth and similar wireless technologies) allowing the system to pair with a user's handheld device, thus allowing the handheld device to provide user-interface functionality, etc., may be sufficient. Mobile-computing devices contemplated for use with the present system may include; cell phones, smartphones, laptops, notebooks, tablet/slate PCs, netbooks.

A memory 170 may be embedded in the subcomponent housing 108 and may be electrically coupled to the energy storage module 130. The memory 170 may be configured to store an application 124 operable to communicably couple the communication module 152 with the external wireless communication network 134 using the transceiver 160 and establish full-duplex communications between the communication module 152 and the external wireless communication network 134, local wireless device, or both. The application 124 may enable interoperation of the communication module 152 and the user interface 150. The memory 170 may include digital memory devices (e.g., fixed and removable cards, chips, drives, etc.) and may include other local networked storage devices. The system may include slots for a subscriber identification module, commonly known as a SIM card 30. The SIM card 30 may be operably coupled to the memory and the processor.

The handlebar 102 may further include a processor 180 embedded in the subcomponent housing 108. The processor 180 may be electrically coupled to the energy storage module 130 and communicably coupled to the communication module 152, the memory 170, and the user interface 150. The processor 180 may be configured to execute the application 124 upon detecting user interaction with the handlebar system 100. One version allows the processor 180 to be mounted to a mainboard or motherboard 302, as shown. The motherboard 302 may include the memory 170 and system modules supporting mobile-phone-communication capability. In some versions of the system, the subcomponent housing is configured to allow the motherboard to be replaceable and may be configured to have loose drop-in components. In this arrangement, a user may configure the handlebar to include specific user-selected features and may upgrade the handlebar, as needed.

Other system arrangements such as providing one of several versions of the motherboard, unpopulated motherboards (a motherboard with a processor), adaptors for connecting updated versions of the processor, arranging for upgrades either by downloading new firmware or adding/replacing hardware components, etc., may be sufficient. In some system arrangements, the “subcomponent housing” may itself be structured and functioned as a “motherboard” on which computer components may be mounted. The handlebar may be configured and arranged as a housing (akin to a computer case) into which small computers and components may be mounted.

The handlebar system may have a micro heat-pipe/plate, thermal-cycle condenser, exchanger, or similar cooler technology to cool and lower the temperature of the electronic handlebar components. A dedicated touch-screen display panel 300 may also be provided, as shown. It should be appreciated that, under circumstances, considering the above-noted issues, providing handlebar systems structured and operated without a dedicated onboard microprocessor; w, a communication system comprising a human interface device, an analog data transmitter (wireless or otherwise), and a mobile-device interface is used to communicate important functions such as volume level, music track skipping, etc., from the user to a mobile-computing device, wherein within this communication system, the main components serve these functions; the human interface device may provide options for the user to select and issue the above listed commands; the analog signal transmitter may encode these commands into a wired or wirelessly-transmissible format which may under the appropriate circumstances be carried by an FM carrier signal, an AM carrier signal, an IR/optical signal, or a wired connection; and, the mobile-device interface may receive the transmitted analog signal containing the issued commands and may convert these commands into a signal format appropriate for the receiving device, wherein communication ports supported by the mobile-device interface may include (but are not limited to) the microphone/headphone jack, the USB power/data connection port, etc., wherein such non-microprocessor-based system arrangements may be achieved.

The handlebar 102 may additionally include a GPS module 162. The GPS module 162 may be configured to receive location data associated with a geographic location of the handlebar 102 and cycle 20. The GPS technology described within the present disclosure may include other GNSS systems, such as GLONASS, Galileo, Beidou, and other regional systems. The GPS/GNSS module is configured to provide geolocation and time information when the handlebar 102 is in sight of multiple GPS/GNSS satellites 103.

Multiple safety and security features may be incorporated within the handlebar 102. For example, the system may require the user to login with a variety of protocols, such as password, user name plus password, credit-card scan or entry, RFID dongle, fingerprint login, or other possible accreditation, to turn on various components within the handlebars. Before login, the in unison. Before login, operating the components within the handlebars may be limited or disabled. This feature may be useful in operating, for example, public bicycle sharing systems and rental cycles.

Other safety and security arrangements such as using the system to collect user fees using mobile wallet services, logging-in subscriber, monitoring cycle use, enabling the system to broadcast a marker allowing autonomous vehicle functions to identify the location of a rider and implement collision avoidance, if needed, etc., may be sufficient.

The subcomponent housing 108 may include a mobile-device holder 140 fixed to the subcomponent housing 108. The mobile-device holder 140 may be adapted to hold the user's mobile-computing device 110 during operation of the cycle 20. The mobile-device holder 140 may include a clamshell hinged cover allowing the user's device to be installed and removed from the subcomponent housing 108. The mobile-device holder 140 may be arranged as a weather-tight enclosure having water-resistant gaskets and seals. Thus, the mobile-computing device 110 may be conveniently held and protectively enclosed within the subcomponent housing 108 during use.

Other pairing arrangements such as providing a cartridge feed assembly configured to slidably receive the mobile-computing device within the subcomponent housing, providing cartridge feed assemblies adapted to securely hold a specific brand, model, or type of mobile-computing device, providing a power cable within the holding enclosure to supply power from the onboard battery to the user's mobile-computing device, etc., may be sufficient.

In some versions of the handlebar system 100, the communication module 152 may further comprise a mobile-device interface module 164, configured to form a paired communication link with at least one mobile-computing device 110. The mobile-device interface module 164 may operate using a wireless connection, allowing the handlebar 102 to connect to the user's mobile-computing device 110 when placed in the mobile-device holder 140 or anywhere within wireless-signal transmission range. Alternately, the mobile-device interface module 164 may operate using a wired connection. In this arrangement, the mobile-device holder 140 may have device-compatible cables.

The processor 180 may be configured to execute the application 124 upon detecting user interaction with the handlebar system 100. In some versions, the processor 180 may be configured to execute the application 124 upon detecting a data-network connectable mobile-computing device 110 within proximity of the handlebar system 100. In this arrangement, a requesting device may be connected once appropriate credentials are determined. This determination may be based on stored information associated with the device or system.

In some applications, the mobile-computing device 110 may be sealed within the mobile-device holder 140 in a semi-permanent manner. For example, a bike-rental vendor may secure a computer tablet or similar mobile device within the holding enclosure using tamper-proof fasteners. The cover of the mobile-device holder 140 may include a transparent cover formed from a material compatible with operating the touch-screen display panel of the mobile-computing device 110. In this arrangement, the mobile-computing device 110 may form an interface between the rental customer and the bike-rental vendor. The rental customer may utilize the mobile-computing device 110 to complete a rental transaction, receive map and route information, receive music and video content, etc. In versions, the bike-rental vendor may use the system to monitor the bike's location and status, send and display advertising content, etc. The system may register a recognized or unrecognized mobile smart device to gain the use of the bicycle. In this arrangement, a user may utilize the network communication capability of the handlebar system to complete a rental transaction using a remote server. Alternately, the handlebar system may be configured to allow the rental transaction to be completed on the user's device using a paired connection with the handlebar system 100.

Other system interactions such as implementing communication between the handlebar system and bicycle rental/storage stations, each station enabling a customer to rent, pickup, and return a bicycle, such stations including a locking mechanism adapted to release the bicycle once a rental has been validated by the system, etc., may be sufficient.

Preferred versions of the handlebar system 100 may include sensors 167, which may interoperate with the processor 180 or other onboard features. The sensors 167 may include but are not limited to a battery-charge sensor, a tire pressure sensor, a wheel-speed sensor, a crank-speed sensor, an accelerometer, a magnetometer (solid-state compass), a proximity motion sensor, a temperature sensor, an ambient light sensor, a humidity sensor, a biometric sensor (for user authentication), wireless-signal proximity sensor, an audio sensor, etc. Preferred versions of the handlebar system 100 may further include a user-monitoring module 144 configured to monitor the duration of use, location history, and user data. Also, versions of the handlebar system 100 may include a security notification module 146 configured to report unauthorized use of the cycle 20 to which the apparatus is mounted. These security features may include sensors and alarms. And they may interoperate with the processor 180 and onboard GPS module 162 to identify unauthorized movement or use of the cycle 20.

The system may be configured to communicate with a software application (i.e., App 187) installed on the user's mobile device. In this manner, the user or monitoring entity may be alerted to any unauthorized tampering or movement of the cycle 20. Alternately, the application 124 may include security codes or linkages configured to interoperate with the “built-in” devices (e.g., handlebar phone/tablet/device). Such codes or linkages may include pin codes, “credit-card authorization”, physical keys, RFID identification, near-field communication, biometric fingerprint, or retinal identification, verified user identification, private or public keys, etc. The codes or linkages may be configured to control the onboard peripherals, including the operation of items such as cameras, system lockdowns, and “physical lock engagements” installed in the cycle 20 or interoperating with the cycle. The code may utilize the speaker upon detecting unauthorized movement of the cycle 20 (e.g., sounding an alarm or play a prerecorded message annunciating that “this bike has been stolen”, etc.)

And the handlebar 102 may further include an image-capture module 126 (such as a camera) configured to capture and store images. The image-capture module 126 may be configured to be controllable using the user interface 150 or by the mobile-computing device 110 using the docked connection. The image-capture module 126 may be adapted to provide still and motion-video-capture capability. This feature permits users to record their rides for documentation, information, safety, etc. The system is further adapted to provide video feed live from the camera(s), transmitted, or projected by a smart device or computer, etc. For example, users in a biking competition or training can record their ride and have a monitor or coach identify incorrect techniques and effectively improve on their race times and general performance. Remote access to live video can be used for athletic evaluation, for security reasons, such as when a bike has been stolen. A user of a stolen bike may remotely acquire video and location information from their missing bike. Police and other individuals may use video data to interface with their team and either send or receive important video or data streams. A general user may continuously record a ride to document the trip and environment around them. The image-capture module 126 may include multiple video-capture elements 136, as shown. The image-capture module 126 may be adapted to process video feeds from the multiple video-capture elements in real time. Thus, bicycle or motorcycle police may implement continuous and comprehensive video acquisition procedures.

Referring again to FIG. 2 and FIG. 3, the subcomponent housing 108 may include a set of modular receivers 182 to permit a user to select and attach, either physically or with network technology, a set of ancillary devices and components. The subcomponent housing 108 may be outfitted as a platform for a variety of accessories 184 that may be installed within the handlebars, thus allowing the user to customize the handlebar as needed. Such accessories 184 may include video-capture elements 136 (cameras), lights 186, telescoping and retractable booms 188 (to support the cameras), GPS modules (reporting time and place), credit-card readers, communication interfaces adapted to interoperate with “smart helmets” and other smart devices, sensors, etc. we note that the accessories 184 may be designed with low profiles and rounded shapes to reduce aerodynamic drag. It should also be noted that the depicted modular accessories 184 may be permanently within the housing assembly, as illustrated by the light 186 in FIG. 6.

Referring again to FIG. 1, the cross-member 120 of some versions of the handlebar system 100 may include a mounting stem 224 configured to assist in mounting the steering headset 225 of the cycle 20. The mounting stem 224 may include a quick release feature 154 configured to enable quick release of the mounting stem 224 from a steering headset 225 of the cycle 20 or a quick release of the handlebar from the mounting stem. The quick release feature 154 can be used in these ways but not limited to detachment removal and reattachment of the full handlebar system from the stem or headset of the cycle 20. The quick release feature 154 is configured to disconnect the structural handlebar and disconnect assemblies of the mechanical and electronic cables, including brakes, transmission, speed controls, battery connections, motor connections, and controllers.

The quick release feature 154 may extend to detachment, removal, and reattachment of the component elements inside the handlebar 102, including computing elements, batteries, and modular elements held in cartridge feed and modular mounting elements. This device mechanism (quick release or attachment feature) may enhance security. It may create easy access to apps, data, information, components, devices, etc., thus allowing for easy access should future repairs and upgrades to the components and mechanism within the handlebar system 100 be needed or desired.

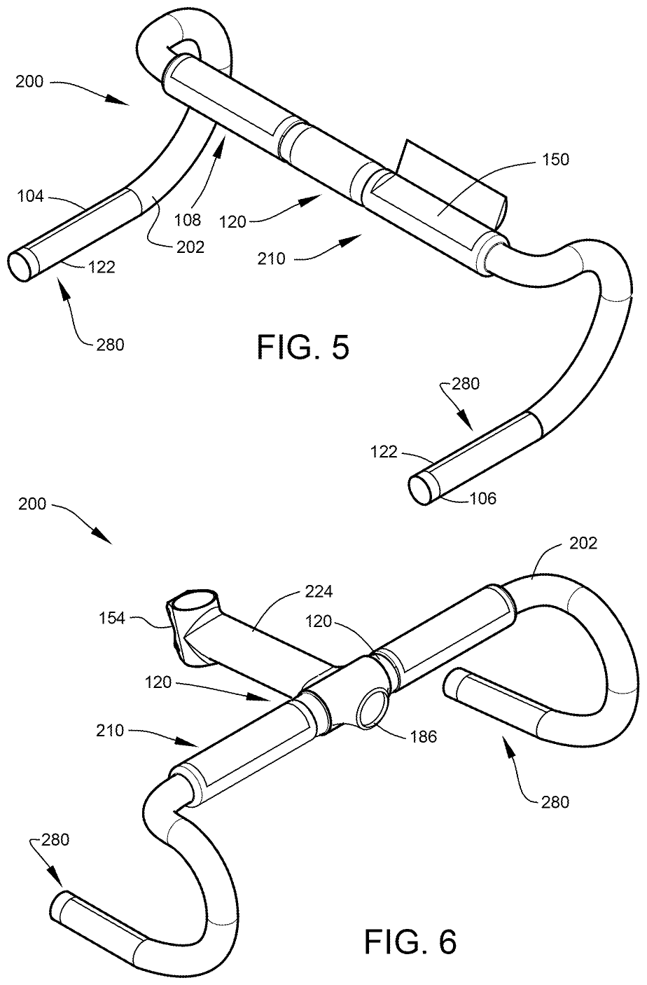

Some versions of the disclosed system are arranged such that the computer and communication functions are permanently within the handlebar element. FIG. 5 is a front perspective view illustrating an alternate handlebar 200 having the functions of a mobile-computing device permanently within the handlebar. FIG. 6 is a rear perspective view of the handlebar 200 of FIG. 5, according to a version of the handlebar system 100. In the depicted alternate handlebar 200, the subcomponent housing 108 may be modeled after the shape of a traditional cycle handlebar, as shown. Alternately, the alternate handlebar 200 may be shaped like the handlebar 102 of FIG. 1.

Referring to FIG. 4, the subcomponents illustrated in FIG. 4 may be permanently mounted within the subcomponent housing 108. In this arrangement, the user need not carry their own mobile-computing device 110 because those functions are within the handlebar.

The alternate handlebar 200 may be configured to wirelessly communicate with at least one other remote device 132 using a wireless link to at least one wireless communication network 134.

All versions of wireless communication networks and links disclosed in this document include any one or any combination of cellular networks, WiFi networks, satellite networks, Bluetooth networks, networks using CAN bus protocols, ANT networks, FM networks. Such cellular and mobile networks may include, but are not limited to, Global System for Mobile Communication (GSM), Universal Mobile Telecommunications System (UMTS/3G), Code-division multiple access (CDMA), Long-Term Evolution (LTE), IMT Multi-Carrier (IMT-MC), etc. This feature allows the user to, for example, make phone calls, download music, receive news updates, upload video content, process data streams from the cycle, etc. The remote device 132 may include servers that may send and receive data and provide smart device applications for download. Such servers may be allowed users to register and obtain an account linked to their handlebar system or mobile smart device.

Upon reading this specification, it should be appreciated that, under circumstances, considering such issues as user preferences, design preference, technological advances, etc., other network arrangements such as using other network protocols developed networks, etc., may be sufficient.

The handlebar 102 may further include an audio-signal processing module 138 configured to process audio signals received from and sent to the mobile-computing device 110. This added feature is configured to provide music and audio capability allowing cyclists and motorcycle riders to listen to music as they ride. Police officers may also use audio to speak with their station or connect to a loudspeaker. When the device connects to a loudspeaker, it functions as a bullhorn device. The handlebar 102 may include red and blue flashing lights, sirens, police-specific communication devices, cameras.

Versions designed for law-enforcement may omit cellular-communication components opting instead for conventional radio components such as those using typical law-enforcement frequencies: dedicated FM, VHF, or UHF police bands.

The audio-signal processing module 138 may include a Digital-to-Analog Converter adapted to convert digital audio information into an analog speaker signal. The audio-signal processing module 138 may also include an amplification feature to amplify the audio signal sent to the speaker 112. In some versions, the audio-signal processing module 138 may be incorporated within the processor 180, as shown. The audio-signal processing module 138 may be adapted to process audio signals received by the microphone 114. Those with ordinary skill in the art will now appreciate that upon reading this specification and understanding the art of audio processing as described, methods of implementing such devices will be understood by those knowledgeable in the art.

FIG. 7 is a detailed view of a user interface 150 of the alternate handlebar 200 of FIG. 5. A user interface 150 may include radio selector buttons 202, web-based music access buttons 204, adapter control buttons 206 to download music, and data/power access ports 208, among others. The user interface 150 may be protected by a hinged cover 210, as shown. Onboard power may be provided by or supplemented by a photovoltaic panel 133, as shown. Additional power may be provided by other solar cells mounted to the bike.

FIG. 8 is a detail view of an alternate user interface 150 of the alternate handlebar 200 of FIG. 5. The manual input 116 of the mobile-computing device 110 may include an alphanumeric keyboard 118, as shown. The alphanumeric keyboard 118 may make out-going phone calls, input password for login protection, manually adjust volume, input credit-card numbers, etc. In versions, the manual input 116 may include a “911” emergency-call button adapted to initiate the transmission of an emergency response request. A key could be programmed to initiate instant-on recording of audio and video. A separate module may be provided to take credit cards for rental usage, for instance.

Versions of the mobile-computing device 110 may further include a visual-display module 142 configured to display images. The visual-display module 142 may display phone information, text, graphics, still camera images, and video. In some versions of the handlebar system 100, the visual-display module 142 may include a touch-enabled surface configured to generate a signal corresponding to a touched location within the touch-enabled surface. In other versions of the system, the touch-enabled surface may implement the alphanumeric keyboard 118. Rearview imagery (to see approaching traffic from behind), and near and far vehicle identification, could also be shown on screen.

In some versions of the handlebar system 100, the visual-display module 142 may be coupled to a television receiver adapted to receive and process an over-the-air TV signal. Over-the-air television is a term used to describe television signals broadcast by a local television broadcast tower (instead of a cable or satellite signal). For example, the handlebar system 100 may be adapted to receive and process digital high-definition television (HDTV) in the United States. This feature allows HDTV content to be displayed on the system with no subscription or monthly fees.

The user interface 150 of FIG. 8 may also include programmable buttons 212 to allow the user to control the tilt, pan, zoom, and focus of the onboard cameras. The user interface 150 of FIG. 8 may also include on-off buttons 214, Bluetooth buttons 216, file transfer buttons 218, video-capture buttons 220, and camera mode buttons 222, as shown. The user interface 150 of FIG. 8 may interoperate with apps 187 (i.e., software applications) to download, save, and share the videos and pictures from the ride.

The version of FIG. 1 may also include a dedicated mobile-computing device 110 permanently or removably installed within the subcomponent housing 108. In this alternate arrangement, the subcomponent housing 108 may be structured and received a mainboard or motherboard 302 containing the processor 180, memory 170, and system modules supporting mobile-phone-communication capability. The handlebar system may have a micro heat-pipe/plate, thermal-cycle condenser, exchanger, or similar cooler technology to cool and lower the handlebar electronic components' temperature and adjust the temperature of the rider interface. For instance, warming the handlebars in the winter and cooling them in the summer. A dedicated touch-screen display panel 300 may also be provided, as shown.

Referring again to FIGS. 3 and 6, the cross-member 120 of versions of the handlebar system 100 may include a mounting stem 224 configured to assist in mounting the version to the steering headset 225 of the cycle 20 (see FIG. 1). The mounting stem 224 may include a quick release feature 154 configured to enable quick release of the mounting stem 224 from a steering headset 225 of the cycle 20 or a quick release of the handlebar from the mounting stem. The quick release feature 154 may be of a standard cam-type design with manually operable levers, threaded fasteners, etc. for locking and releasing the steering headset 225. Threaded fasteners can be locked under access plates making the handlebar more secure against theft. As noted, the quick release may also release the cables.

According to one version, the device may be arranged as a kit 158, as illustrated in FIG. 3. The kit 158 may include a set of instructions 156, as shown. The instructions 156 may detail functional relationships about the system (such that the version can be used, maintained, or the like, in a preferred manner). The kit 158 may also contain accessories 184 in FIG. 2.

Other kit arrangements such as including mounting hardware, tools, rearview mirrors (or video displays), locks, antennae, credit-card readers, the cycle, etc., may be sufficient.

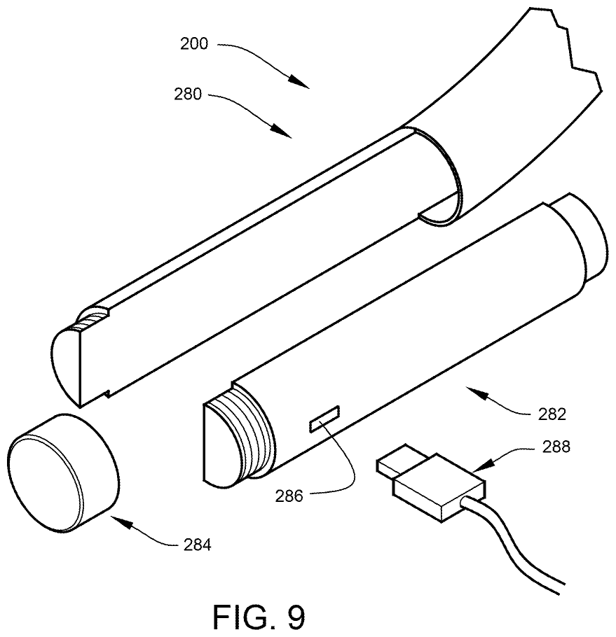

FIG. 9 is a detailed view of an alternate set of handgrips. The alternate hand grips 280 may incorporate the energy storage module 130 as a removable battery pack 282. The removable battery pack 282 may include a portion of the handgrips 280 held in place by a threaded retainer 284, as shown. The battery pack 282 may include a charge port 286, allowing the battery pack 282 to be recharged using a charging cable 288. The charge port 286 may also supply power to the rider's compatible accessories.

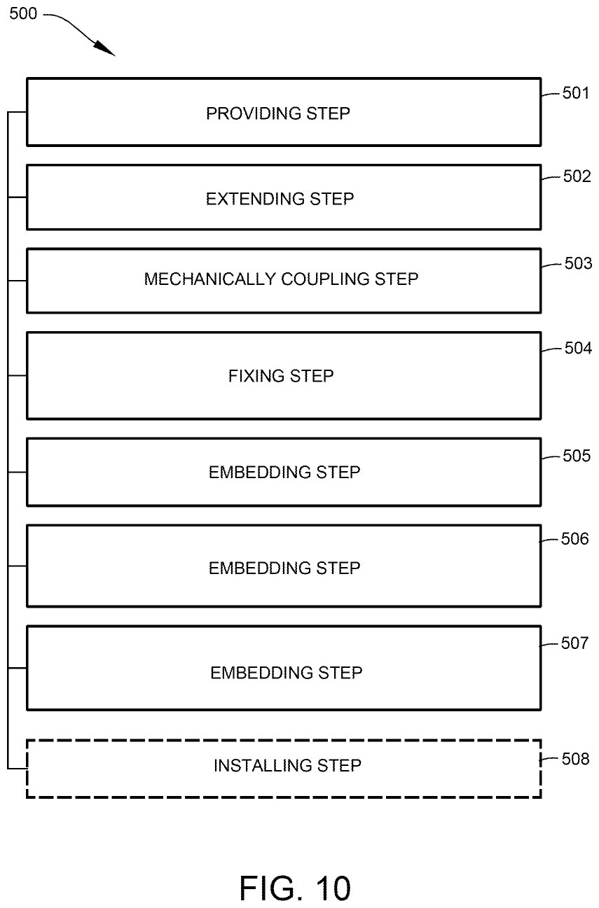

FIG. 10 is a flow diagram illustrating a handlebar method 500. As illustrated, the handlebar method 500 may include the steps of step one 501, providing a handlebar 102 configured to attach to and steer the cycle, the handlebar having a left-hand end and a right-hand end; step two 502, extending a cross-member 120 between the left-hand end and right-hand end, the cross-member including a subcomponent housing; step three 503, mechanically coupling an energy storage module to the subcomponent housing; step four 504, fixing a user interface 150 to the subcomponent housing, the user interface including a speaker, a microphone, and at least one manual input, the user interface adapted to communicate a command from the user; step five 505, embedding a communication module in the subcomponent housing, the communication module including a transceiver electrically coupled to the energy storage module, the transceiver configured to wirelessly communicate with at least one external communication network; step six 506, embedding a memory 170 in the subcomponent housing, the memory electrically coupled to the energy storage module, the memory configured to store an application, the application operable to communicably couple the communication module with at least one external communication network using the transceiver and establish a communication link and provide for interoperation of the communication module and the user interface; and step seven 507, embedding a processor in the subcomponent housing, the processor electrically coupled to the energy storage, and communicably coupled to the communication module, the memory, and the user interface, the processor configured to execute the application upon detecting user interaction with the handlebar system. The handlebar method of use 500 may include step 508 of installing the handlebar 22 on the cycle 20.

Step 508 is optional and may not be always implemented. Optional steps of method 500 are illustrated using dotted lines in FIG. 10 to distinguish them from the other steps of method 500.

The versions of the invention described are exemplary. Numerous modifications, variations, and rearrangements can be readily envisioned to achieve substantially equivalent results, which are intended to be embraced within the invention's spirit and scope. Further, the purpose of the abstract is to enable the governing Patent and Trademark Offices and the public generally, and especially the scientist, engineers, and practitioners in the art who are not familiar with patent or legal terms or phraseology, to determine quickly from a cursory inspection the nature and essence of the technical disclosure of the application.

Different versions include the following.

Versions
Networking
   New aspects of “IOT”—Internet of things
   New variations of “Mesh” networks
   New implementations of “low power, low data transmission” and Cell networks
   Networking is “multi-hop.”
   Interface from “Pilot”/“Rider” to the computer (may involve accessories like “headsets”, “cell phones”, “sensors” (heart monitors)
   Interface to “Computer” with Handlebar—network to the rider
   Locally networking to other vehicle components and the immediate surroundings—taillights (including “blinker, brake, marker, emergency” “headlight” (for vision, marking, alarm), “battery system”, “motor”, “trailer monitor”, other individuals (bikes, cars, pedestrians), or objects (the road, vs. the side of the pavement)
   Wide Area Network/Internet
   Secured “WAN” to “data centers” for personal data logging or archiving or application-specific data, email, media archiving, log tracking, etc.
   Secured WAN may facilitate a “bike rental” or “vehicle rental” app to track assets, acquire payment, and customer information, etc
   Unsecured “Internet” for “Mapping”, Information lookup, etc., sharing of information to Social Media and general cookie-like tracking that undoubtedly follows
   GSM; GSMA; LTE; CAT MI; NB LOT; PCS; TDMA; AMPS; TACS; 5G NR; UMTS; CDMA; WiMAX; Roaming; Dual-band; Tri-band; Quad-band; Microwave; BACNET; CANBUS; MODBUS; Zigbee-cellular, WiFi; WAN; IP; IOT; UDP; V2x vehicle to vehicle; Vehicle to everything; Serial mesh and grid networks; ADAS-sensors; Lidar; Radar; Lidar; HMIS
   4K/8K screens or head-up displays (HUD); Anti-theft tracking device=GPS; Audio alert wireless siren device=sensors; LED device=sensors; BPL—RADIO frequency, HIGH-SPEED DIGITAL DATA TRANSMISSION OVER PUBLIC ELECTRIC FREQUENCIES, POWER GRIDS
Safety-Security
   Video logging
   Power system shutdowns
   Tracking (has been mentioned)
   Fingerprint reader (potential in scanning application)
   Voice recognition (call 911)
   Lighting and Lighting control
   Awareness of surroundings through video and sensor implementation
   Recording and monitoring environment (other vehicles, (automatic safety lighting) beacons to other vehicles and even Stop Lights
   911 calls
   General SOS button potential
   Documentation—i.e., from accidents or problems found while riding
   Personal Marker—GPS registration

Connectivity
Hot Spot service while stopping to rest, camp, etc Information
Mapping
Danger Zones
Points of Interest
Alternative Routes

Bike Logs
full battery start
battery state
power meter—how much input from the rider
safety logs—brakes, tires, psi in tires, general service
Alerts and Alarms

Operational Issues
Electro-Mechanical reliability
Heating and Cooling
   Processing and battery operation generates heat
   heat must be shed
   heat to “warm the handgrips”
   heat shield to warm the cockpit area
A shroud on the computer
   Protects from the wind—keeps some ambient warmth
   Could keep the Screen shielded from the rain
   Would aid in aerodynamics
   Could be a modular option
   Could support aspects of Solar collection
Battery Life
Wiring Routes
Strain Gauges could be used and monitored in various subsystems of the bike
Battery/Motor (if there is one) Information
   “miles to empty”
   gauging rider and battery input
   various “Info Streams accessible in the display”
   Solar Input
   Extra Battery capability
   Generator (i.e., hub) input
   Power metering—where is power being used? Motor. Computer. Display etc
Efficiency
   the efficiency of power management and usage
   the efficiency of the computer/user interface
   See Power Metering and the section above
Cockpit Control
   Gauges
   Inputs
   Display
   Normal Bike riding
   Mirror, rain. or aerodynamic shield
   Blinker control
   Emergency lighting control
   Radio Beacon—control
   Odometer
   PSI
   Rider Input (power output, hours on the bike, etc.)
   Power Meter
Virtual Racing
Video Mixing
   Three or more synchronized streams
   bike as a content acquisition system

### Exemplars

Exemplar1. A handlebar system comprising:
a removable central unit comprising
   a housing
      a mount between the housing and a handlebar
      a power supply in the housing
      a user interface in the housing
      a communication module comprising a network transceiver in the housing
      a memory in the housing containing computer code
      and
      a processor in the housing connected to the power supply, the memory, and the communication module
         wherein the code causes the processor to
signal the communication module to connect with a first external network using the transceiver to establish link A between the communications module and the external network or an access point on the external network
and
receive and signal the user interface and communications module.

Exemplar2. The handlebar system of Exemplar1 wherein the wireless connection is carried on any external network.

Exemplar3. The handlebar system of Exemplar2 wherein the external network is any one or any combination of a cellular network, a wireless local area network, a wireless wide area network, a Wi-Fi local area network, a satellite network, a Bluetooth personal area network, a controller area network, a CAN bus, an ANT multicast wireless sensor network, an FM network, a GSM network, a UMTS/3G network, a CDMA network, an LTE network, an IMT-MC network, a GSMA network, a CAT MI network, an NB LOT network, a PCS network, a TDMA network, an AMPS network, a TACS network, a 5G NR network, a WiMAX network, a roaming network, Dual-band network, a Tri-band network, a Quad-band network, a microwave network, a BACNET network, a MODBUS network, a Zigbee network, a Zigbee-cellular network, a WiFi network, a WAN, an IP network, an IOT network, a UDP network, vehicle-to-vehicle networks, vehicle-to-everything networks, serial-mesh and grid networks, ADAS-sensors and network, and an HMIS network.

Exemplar4. The handlebar system of Exemplar2 further comprising an image-capture module (ICM) comprising a video-capture element that produces still or video data streams.

Exemplar5. The handlebar system of Exemplar4, wherein the user interface or the mobile computing device are configured to send ICM signals to the image-capture module.

Exemplar6. The handlebar system of Exemplar5 wherein the ICM signals pass through the processor.

Exemplar7. The handlebar system of Exemplar6, wherein the ICM comprises at least another video-capture element, and the code causes the processor to process some of the still or video data streams from the multiple video-capture elements in real time.

Exemplar8. The handlebar system of Exemplar7, further comprising an ancillary device that processes some of the video data streams in real time.

Exemplar9. The handlebar system of Exemplar7, wherein the code causes the processor to process the still or video data streams from the multiple video-capture elements in real time.

Exemplar10. The handlebar system of Exemplar9, further comprising a weather-tight, mobile-device holder connected to the housing.

Exemplar11. The handlebar system of Exemplar10, further comprising at least one audio-signal processing module configured to process audio signals received from and sent to the user interface.

Exemplar12. The handlebar system of Exemplar10, wherein the user interface further comprises manual inputs that includes an alphanumeric keyboard and a manually adjustable volume control.

Exemplar13. The handlebar system of Exemplar10, further comprising at least one audio-signal processing module configured to process audio signals received from and sent to the user interface or headset.

Exemplar14. The handlebar system of Exemplar11, wherein the user interface further comprises at least one manual input that includes an alphanumeric keyboard or a manually adjustable volume control.

Exemplar15. The handlebar system of Exemplar14, wherein the user interface further includes at least one visual-display module configured to display images.

Exemplar16. The handlebar system of Exemplar15, wherein the at least one visual-display module includes a touch-enabled surface configured to generate a signal corresponding to a touched location within the touch-enabled surface.

Exemplar17. The handlebar system of Exemplar16, further comprising a user-monitoring module configured to at least monitor duration of use, location history, and user data.

Exemplar18. The handlebar system of Exemplar17, further comprising a security notification module configured to report unauthorized use of the handlebar system.

Exemplar19. The handlebar system of Exemplar2 wherein the wireless connection is carried on any external network except cellular and mobile-phone-based networks.

Exemplar20. The handlebar system of Exemplar19, wherein the communication module further comprises a mobile-device interface module and the code causes the processor to signal the communication module to connect with a second external network using the mobile-device interface module to establish link B between the communications module or the mobile-device interface module.

Exemplar21. The handlebar system of Exemplar20 wherein link B is a connection between the communications module or the mobile-device interface module and a mobile-computing device.

Exemplar22. The handlebar system of Exemplar21 further comprising an image-capture module (ICM) comprising a video-capture element that produces still or video data streams.

Exemplar23. The handlebar system of Exemplar22, wherein the user interface or the mobile computing device are configured to send ICM signals to the image-capture module.

Exemplar24. The handlebar system of Exemplar23 wherein the ICM signals pass through the processor.

Exemplar25. The handlebar system of Exemplar24, wherein the ICM comprises at least another video-capture element, and the code causes the processor to process some of the still or video data streams from the multiple video-capture elements in real time.

Exemplar26. The handlebar system of Exemplar25, further comprising an ancillary device that processes some of the video data streams in real time.

Exemplar27. The handlebar system of Exemplar25, wherein the code causes the processor to process the still or video data streams from the multiple video-capture elements in real time.

Exemplar28. The handlebar system of Exemplar27, further comprising weather-tight, mobile-device holder connected to the housing.

Exemplar29. The handlebar system of Exemplar28, further comprising at least one audio-signal processing module configured to process audio signals received from and sent to the user interface.

Exemplar30. The handlebar system of Exemplar29, wherein the at least one manual input of the user interface includes an alphanumeric keyboard and a manually adjustable volume control.

Exemplar31. The handlebar system of Exemplar30, wherein the user interface further includes at least one visual-display module configured to display images.

Exemplar32. The handlebar system of Exemplar31, wherein the at least one visual-display module includes a touch-enabled surface configured to generate a signal corresponding to a touched location within the touch-enabled surface.

Exemplar33. The handlebar system of Exemplar32, further comprising a user-monitoring module configured to at least monitor duration of use, location history, and user data.

Exemplar34. The handlebar system of Exemplar33, further comprising a security notification module configured to report unauthorized use of the handlebar system.

What is claimed is:

1. A handlebar system comprising:
a central unit comprising
a housing
a power supply in the housing
a user interface in the housing
a communication module comprising a network transceiver in the housing
memory in the housing containing computer code
and
a processor in the housing connected to the power supply, the user interface, the memory, and the communication module,
wherein the code causes the processor to
signal the communication module to establish link A between the communications module and an external network or an access point on the external network using the transceiver
and
receive signals from and send signals to the user interface and communications module.

2. The handlebar system of claim 1 wherein the wireless connection is carried on any external network.

3. The handlebar system of claim 2 wherein the external network is any one or any combination of a cellular network, a wireless local area network, a wireless wide area network, a Wi-Fi local area network, a satellite network, a Bluetooth personal area network, a controller area network, a CAN bus, an ANT multicast wireless sensor network, an FM network, a GSM network, a UMTS/3G network, a CDMA network, an LTE network, an IMT-MC network, a GSMA network, a CAT MI network, an NB LOT network, a PCS network, a TDMA network, an AMPS network, a TACS network, a 5G NR network, a WiMAX network, a roaming network, Dual-band network, a Tri-band network, a Quad-band network, a microwave network, a BACNET network, a MODBUS network, a Zigbee network, a Zigbee-cellular network, a WiFi network, a WAN, an IP network, an IOT network, a UDP network, vehicle-to-vehicle networks, vehicle-to-everything networks, serial-mesh and grid networks, ADAS-sensors and network, and an HMIS network.

4. The handlebar system of claim 2 further comprising an image-capture module (ICM) comprising a video-capture element that produces still or video data streams.

5. The handlebar system of claim 4, wherein the user interface or the mobile computing device are configured to send ICM signals to the image-capture module.

6. The handlebar system of claim 5 wherein the ICM signals pass through the processor.

7. The handlebar system of claim 6, wherein the ICM comprises at least another video-capture element, and the code causes the processor to process some of the still or video data streams from the multiple video-capture elements in real time.

8. The handlebar system of claim 7, further comprising an ancillary device that processes some of the video data streams in real time.

9. The handlebar system of claim 7, wherein the code causes the processor to process all of the still or video data streams from the multiple video-capture elements in real time.

10. The handlebar system of claim 2 wherein the wireless connection is carried on any external network except cellular and mobile-phone-based networks.

11. The handlebar system of claim 10, wherein the communication module further comprises a mobile-device interface module and the code causes the processor to signal the communication module to connect with a second external network using the mobile-device interface module to establish link B between the communications module or the mobile-device interface module.

12. The handlebar system of claim 11 wherein link B is a connection between the communications module or the mobile-device interface module and a mobile-computing device.

13. The handlebar system of claim 12 further comprising an image-capture module (ICM) comprising a video-capture element that produces still or video data streams.

14. The handlebar system of claim 13, wherein the user interface or the mobile computing device are configured to send ICM signals to the image-capture module.

15. The handlebar system of claim 14 wherein the ICM signals pass through the processor.

16. The handlebar system of claim 15, wherein the ICM comprises at least another video-capture element, and the code causes the processor to process some of the still or video data streams from the multiple video-capture elements in real time.

17. The handlebar system of claim 16, further comprising an ancillary device that processes some of the video data streams in real time.

18. The handlebar system of claim 16, wherein the code causes the processor to process all of the still or video data streams from the multiple video-capture elements in real time.
